(19) United States
(12) Patent Application Publication
(10) Pub. No.: US 2023/0125781 A1
(43) Pub. Date: Apr. 27, 2023

(54) ANIMAL NUTRITION SUPPLEMENTATION

(71) Applicants: UPL Corporation Limited, Port Louis (MU); UPL Europe LTD, Warrington (GB)

(72) Inventors: Marco Oswaldo Samaniego Astudillo, Saltillo (MX); Mario Ramon Villareal Cárdenas, Saltillo (MX); Maria De Lourdes Delgado Hernandez, Europa, Z.C (MX); Mauricio Alberto Vargas Martínez, Saltillo (MX); Marín Virgilio Valdes Caballero, Saltillo (MX)

(21) Appl. No.: 17/769,451

(22) PCT Filed: Oct. 15, 2020
(86) PCT No.: PCT/IB2020/059679

§ 371 Date: Apr. 15, 2022

(30) Foreign Application Priority Data
Oct. 15, 2019 (IN) 201921041768

(51) Int. Cl. A23K 20/137; A23K 20/111; A23K 50/15; A23K 50/75

(52) U.S. Cl. CPC A23K 20/137; A23K 20/111; A23K 50/15; A23K 50/75

(57) ABSTRACT

The present invention relates to an animal feed supplement/additive composition comprising a humic substance and an ureide. The invention also relates to a method that is capable of increasing feed efficiency, improving appetite and increasing feed uptake, live weight and growth rate.

### FIELD OF INVENTION

The present invention relates to an animal nutrition supplementation, particularly a composition as supplement/additive in animal feed to enhance growth in production animals.

More particularly, the present invention relates to an improved animal feed composition.

### BACKGROUND OF INVENTION

In developing countries, livestock are fed mainly on low quality roughages, including natural grazing and agro-industrial by-products, such as cereal straws/stovers, sugarcane by products and by-products of food processing industries, all of which contain large quantities of ligno-cellulosic material. These feeds are deficient in protein, energy, minerals and vitamins.

Growth promoters played a vital role in enhancing the efficiency of animal production for many years. There have also been tremendous developments in recent years in the search for methods of influencing growth rate and carcass composition by manipulation of the physiological control mechanisms.

Antimicrobial feed additives are also worldwide used in animal husbandry to improve the economy and ecology of animal production by increasing growth rate, reducing feed expenditure per gain and lessening the risk of disease. Further, many antibiotics are used as growth promoters for improving health of animals. However, use of most antibiotic growth promoters has been banned in many countries, because it is risky due to cross resistance amongst pathogens and residues in tissues. Recently, in animal nutrition, health, and well-being have focused on sustainable, organic, non-genetically modified alternatives for animal feeds and feed supplements. Meat and poultry producers need to find growth enhancers that are natural, sustainable and innocuous to animal health since antibiotics present restriction as growth enhancers in production animals. Thus, feed is generally designed for livestock which is inexpensive and contain high amounts of nutritional ingredients in order to promote rapid weight gain in the livestock and to decrease the amount of time needed until the livestock are ready for processing. Thus, natural feeding programs may be beneficial to the long-term health and well-being of the animals. A variety of naturally-occurring and other feed additives have been used to improve the health and well-being of the animals.

Therefore, the present invention provides natural growth promoter which does not cause environmental or residue problems. Surprisingly, the present invention provides natural animal feed supplement that increases feed efficiency, improves appetite and increases feed uptake, live weight and growth rate in animals.

### OBJECT OF THE INVENTION

It is an object of the invention to provide an improved animal feed composition.

It is another object of the invention to provide animal nutrition supplementation to enhance growth in production animals.

It is another object of the present invention to provide a method of manufacturing an animal feed composition.

It is another object of the present invention to provide a method of enhancing the health of an animal by administering an effective amount of an animal feed composition to the animal so as to improve one or more health indicators of the animal.

The present invention described hereinafter meets at least one or more of the above described objectives.

### SUMMARY OF THE INVENTION

In an aspect the present invention provides an animal feed composition comprising a humic substance and an uried.

In another aspect the present invention provides a composition comprising a humic substance, an uried, and an animal feed component.

In another aspect the present invention provides a method of enhancing the health of an animal by administering an effective amount of an animal feed composition to the animal, said composition comprising a humic substance and an uried.

### DESCRIPTION OF THE INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”. The term “about” used to qualify the amounts of active components shall be interpreted to mean “approximately” or “reasonably close to” and any statistically insignificant variations therefrom.

Thus, before describing the present invention in detail, it is to be understood that this invention is not limited to particularly exemplified compositions or process parameters that may of course, vary. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term. Likewise, the invention is not limited to various embodiments given in this specification.

It must be noted that, as used in this specification, the singular forms “a,” “an” and “the” include plural referents unless the content clearly dictates otherwise. The terms “preferred” and “preferably” refer to embodiments of the invention that may afford certain benefits, under certain circumstances.

As used herein, the terms “comprising” “including,” “having,” “containing,” “involving,” and the like are to be understood to be open-ended, i.e., to mean including but not limited to.

In any aspect or embodiment described herein below, the phrase comprising may be replaced by the phrases “consisting of” or “consisting essentially of” or. In these aspects or embodiment, the combination or composition described includes or comprises or consists of or consists essentially of or consists substantially of the specific components recited therein, to the exclusion of other ingredients or excipients not specifically recited therein.

Embodiments of the present disclosure solve one or more of the foregoing or other problems in the art with nutritional products and methods of manufacturing and/or using the same (e.g., to enhance/improve the health of an animal). Specifically, embodiments of the present disclosure include animal nutrition compositions, such as animal feed additives or supplements, and methods of use thereof to enhance the health of an animal.

Therefore, the present invention is in the field of animal production and more specifically in the fields of animal feed and health.

The present invention describes a new additive for animal feed that acts as a natural promoter of animal growth and comprises a humic substance and an ureide compound.

The term growth promoters or stimulators is given to those additives that form an integral part of animal diet and that perform the function of improving the daily weight gain of animals, as well as conversion of the ration consumed. In the present invention, growth promoters or stimulators can be administered by different ways, either by injection, in implants or as an additive in the feed of the animals. In the present invention, the effect of growth is measured as an increase in weight.

The present invention provides natural animal feed supplement/additive that increases feed efficiency, improves appetite and increases feed uptake, live weight and growth rate.

In an aspect, the present invention provides a combination comprising a humic substance and an ureide.

In an embodiment the present invention provides an animal feed composition comprising a humic substance and an uried.

In an embodiment, the present invention provides an animal feed composition comprising a humic substance and an ureide.

In an embodiment, the animal feed composition further comprises at least one plant extract.

In an embodiment the present invention provides a feed composition comprising a humic substance; an ureide; and a plant extract.

In another aspect the present invention relates to a composition of feed supplements for livestock.

In another aspect the present invention relates to a composition which improves growth rate and meat quality of livestock and increases tolerance to diseases.

The animal feed in another aspect of the present invention comprises humic acid, an ureide and a plant extract.

In an embodiment, the humic substances are obtained from natural or synthetic sources. The natural sources of humic substances are, but not limited to, leonardite (naturally oxidized lignite), Peats, composts, organic matter rich soils, and bog, marine and lake sediments. An artificial source can be, but not limited to, chemically oxidized coal and lignins.

In an embodiment, the humic substance is leonardite.

Leonardite is a mineral produced from the oxidation of organic matter from ancient plants and animals. It is a rich source of humic acid with high bioactivity.

In an embodiment, humic substance is used in amount of 10% to about 95% by weight of composition. In an embodiment, humic substance is used in amount of 20% to about 90% by weight of composition. In an embodiment, humic substance is used in amount of 30% to about 90% by weight of composition. In an embodiment, humic substance is used in amount of 40% to about 90% by weight of composition. In an embodiment, humic substance is used in amount of 50% to about 85% by weight of composition.

In an embodiment, the ureides are selected from the group of natural ureides and synthetic substances that have in their molecules the group H2N-CO—NH— carbamylamino.

In an embodiment, the ureides are selected from the group of natural ureides are selected from, but not limited to, which include Glyoxyldiureide (5-ureidohydantoin), 2, 2-Diureidoacetic acid, citrulin (2-amino-5-ureidopentanoic acid), S-ureidoglycine, or S-ureidoglycolate.

In an embodiment the ureide is glyoxyldiureide (also known as 5-ureidohydantoin). In an embodiment the ureide is citrulin.

In an embodiment, ureide is purine-derived ureides such as allantoin and allantoate. In an embodiment, the ureide is allantoin.

Encompassed within this disclosure is all forms of allantoin, or a salt thereof, including, but not limited to, crystals, polymorphs, clathrates, solvates, hydrates, amorphous forms, co-crystals, and anhydrous forms. As used herein, “allantoin” includes salts thereof (as described below), crystals, polymorphs, clathrates, solvates, hydrates, amorphous forms, co-crystals, and anhydrous forms unless otherwise specified.

Embodiments of the present disclosure also relate to the salts of allantoin. The acids which are used to prepare the salts of the aforementioned compound are those which form non-toxic salts, i.e., salts containing pharmacologically acceptable anions, such as the hydrochloride, acetate, trifluoroacetic acid, tosylate, picrate, hydrobromide, hydroiodide, nitrate, sulfate, bisulfate, phosphate, acid phosphate, lactate, citrate, acid citrate, tartrate, bitartrate, succinate, maleate, fumarate, gluconate, saccharate, benzoate, methanesulfonate, ethanesulfonate, benzenesulfonate, p-toluenesulfonate and pamoate salts.

In an embodiment ureide compound is used in an amount of 1% to about 30% by weight of the composition.

In some embodiments the composition comprises about 1% or more of allantoin. In some embodiments the composition comprises about 2% or more of allantoin. In some embodiments the composition comprises about 3% or more of allantoin. In some embodiments the composition comprises about 4% or more of allantoin. In some embodiments the composition comprises about 5% or more of allantoin. In some embodiments the composition comprises about 6% or more of allantoin. In some embodiments the composition comprises about 7% or more of allantoin. In some embodiments the composition comprises about 8% or more of allantoin. In some embodiments the composition comprises about 9% or more of allantoin. In some embodiments the composition comprises about 10% or more of allantoin.

In an embodiment humic substance and ureid is used in a ratio of 1 to 10:10 to 1.

In an embodiment, the composition of present invention comprises one or more additional components which can be selected, independently, from the group consisting of one or more vitamins, minerals, trace minerals, amino acids, health supplements, pharmaceuticals, plant extracts, phytonutrients, carotenoids, enzymes, probiotics, lignosulfonates, and organic acids or combinations thereof.

In an embodiment, the composition of present invention comprises at least one plant extract.

In an embodiment, the plant extract is selected from group of digestive, antimicrobial, biostimulantand aromatic plants from the families: Lamiaceae, zingiberaceae, apiaceae, myrtaceae, musaceae, oleaceae, arecaceae, alliaceae, meliaceae, asteraceae, poaceae, piperaceae, cupresaceae, rutaceae, other extracts such as Lemon balm fluid extract, Ginger extract powder, Fennel fluid extract and the like.

In an embodiment the plant extract is used in an amount of about less than 1% to about more than 30% by weight of the composition

In one embodiment, the present composition comprises

Leonardite (Humic acid)—40 to 95%

Alkali solution—1 to 20%

Ureid compound—1 to 10%

In one embodiment, the present composition comprises

Leonardite (Humic acid)—40 to 95%

Alkali solution 1 to 20%

Allantoin or its salts—1 to 10%

In one embodiment, the present composition

Leonardite (Humic acid)—45%

Liquid Sodium Hydroxide—4%

Liquid Potassium Hydroxide—2% and

Glioxyldiureide—3%

According to the present invention, the animal feed composition of the present invention may be further supplemented by combination with other compounds commonly used in the formulation and/or application of animal feed. Such compounds include, but are not limited to, deposition agents, binders, anti-biotics, feeding attractants, dust control agents and preservatives. It will be understood by one skilled in the art, however, that such additional components are optional to the activity of the present invention. The composition of the present invention further comprises microelements, fluvic acids and/or amino acids to further enhance the effect.

The present additive composition is fed to an animal as dietary supplement.

In an embodiment the animal can be livestock or chicken.

In an embodiment, the present invention provides use of a composition comprising humic acids and ureids as a dietary supplement for animal.

Furthermore, the present invention describes the use of this additive, natural animal growth promoter, in addition to improving productive parameters of animals (for example increasing their weight) or as an immune response modulator in animals for example chickens.

In another aspect the present invention provides use of composition comprising humic acids and ureids as a dietary supplement to broiler chicken.

In another aspect the present invention provides a process for preparation of composition feed supplements.

In an embodiment, the process of preparing an additive composition comprising

a. mixing humic acid compound with ureides

b. optionally, treating said humic acid substance with an alkali solution prior to mixing for activation.

The process in one embodiment comprises mixing leonardite with ureides.

In another embodiment, the process comprises several optional steps which may be performed to provide an improved composition.

In an embodiment, the humic substance may be activated prior to being mixed with ureides.

In this embodiment, activating the humic substance comprises treating said humic acid substance with an alkali solution.

In an embodiment, the humic acid substance is leonadite.

In an embodiment, said alkali is sodium hydroxide or potassium hydroxide or mixture thereof.

In an embodiment, the humic substance is treated with an alkali solution in the presence of water.

In an embodiment, the treated humic substance is cooled prior to being mixed with ureides or optional.

In an embodiment, the mixture of humic substance and ureides is dried at a temperature from about 40° C. to about 140° C.

In an embodiment, a plant extract or a mixture of several plant extracts is added to mixture. The final product is then dried and packed in pouches.

The animal feed of the present composition can be prepared in different forms depending on the intended use thereof. Accordingly, the composition of the present invention is prepared by mixing the effective amount of the essential components of the composition as described above in any mixing apparatus such as horizontal mixer to form a solid composition ready for use as add-on to traditional feed ration. The composition may be packed in individual pouches according to desired amount per pouch. The composition may also be processed further to make it available in different forms or shapes such as pellet, treat, capsule or tablet form. Any forming machines such as extruder, pellet-making or stamping machine are used in producing the desired shape and form.

In an embodiment the present composition can be pre-mixed with any traditional feed ingredients.

The invention further relates to a method for promoting performance and/or appetite promotion in animals which is characterized in that the animal feed according to the invention is fed, which contains the animal feed additive according to the invention.

In an aspect the present invention provides a method of promoting the health and performance-enhancing in animals, by administering to the animals a composition comprising at least one humic substance and at least one uried.

In another aspect the present invention provides a method of promoting growth in animals, wherein said method comprises administration, in an amount sufficient to promote growth in said animals, of a composition comprising at least one humic substance and at least one uried.

In an embodiment, the present invention provides a method for improving feed digestion in animal production, comprising feeding the animal with a feed containing additive composition comprising an effective amount of humic substance and an ureide compound.

In an embodiment the method comprises mixing the composition of the present invention with an animal feed product, thus producing an animal feed composition or an animal feed supplement; and feeding the animal feed composition or the animal feed supplement to the animal.

In another embodiment there is provided a method for feeding one or more animal for example dairy cow, a lactating bovine, a steer calf, and an ovine.

The invention further relates to a method for promoting performance and/or appetite promotion in livestock, which is characterized in that the livestock animal feed according to the invention is fed, which contains the animal feed additive according to the invention.

The invention further relates to a method for promoting performance and/or appetite promotion in poultry, which is characterized in that the pounlty animal feed according to the invention is fed, which contains the animal feed additive according to the invention.

The method comprises mixing the present composition as described herein with conventional animal feed product, thus producing a feed composition or a feed supplement; and feeding the feed composition or the feed supplement to the animal.

The animal feed product may be selected from the group consisting of feed matter, a mineral, a vitamin, an amino acid, an antibiotic, a plant extract, a plant botanical, a sugar alcohol, and combinations of any thereof.

In another embodiments there is provided a method of feeding the present composition product to an animal for example a lactating sow, a gestating sow, a piglet, a dairy cow, a lactating bovine, a steer calf, a gestating ewe, a lactating ewe, and a lamb.

The present invention is applicable to the diet of numerous animals, which herein is defined as including mammals and fowl. In particular, the diet may be employed with commercially significant mammals such as cows, poultry, swine, sheep, goats, laboratory rodents (e.g. rats, mice, hamsters and gerbils), chicken, fur bearing animals such as mink and fox, and zoo animals such as monkeys and apes, as well as domestic mammals such as cats and dogs.

In another embodiment there is provide a package comprising a combination product of at least one humic substance and at least one uried as feed supplement/additive.

In another embodiment there is provide a package comprising a combination product of at least one humic substance and two urieds as feed supplement/additive.

In an embodiment, there is provided a method of producing a nutrient enhanced animal feed product, the method comprising providing an animal feed component and mixing the animal feed component with the feed additive component and feeding the animal with the mixture of the feed additive component and feed component such that the animal ingests the effective amount of the animal feed additive composition.

In an embodiment the composition is mixed with an animal feed component, the feed component comprising solid feed and/or liquid feed, the liquid feed preferably comprising water.

In preferred embodiment the present composition is mixed with the solid feed component or liquid feed component in sufficiently effective amount.

In an embodiment the liquid feed component comprises drinking-water.

### Advantages of the Present Invention

1. Use of present combination in animal feed improved livestock health and improved feed efficiency.

2. It also improved weight gain (body weight) as compared to control. 3. It can be used as alternative to antibiotic growth promoters. 4. Administration of this combination as food supplements showed increase vitality traits such as growth and immunity and reduce diseases in animals.

The invention will now be described in more details with reference to the following examples. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and following examples, but by all embodiments and methods within the scope and spirit of the invention.

### Example 1

Animal Nutrition Supplement Composition

| Ingredients | Amount (%) |
|---|---|
| Leonardite (Humic acid) | 45 |
| Liquid Sodium Hydroxide | 4 |
| Liquid Potassium Hydroxide | 1.8 |
| Glioxyldiureide | 3 |
| Dry extracts | Q.S. |

### Example 2

| Ingredients | Amount (%) |
|---|---|
| Leonardite (Humic acid) | 45 |
| Liquid Sodium Hydroxide | 4 |
| Liquid Potassium Hydroxide | 1.8 |
| Citrulin | 3 |
| Dry extracts | Q.S. |

### Example 3

| Ingredients | Amount (%) |
|---|---|
| Leonardite (Humic acid) | 81.97 |
| Liquid Sodium Hydroxide | 12.40 |
| Liquid Potassium Hydroxide | 1.64 |
| Allantoin | 4.10 |
| Dry extracts | Q.S. |

### Example 4

Trials:

In this trial active leonardite (Humic acid substance) enriched with ureides as supplement/additive is added in conventional animal feed to enhance growth (weight, feed conversion ratio) in chicken.

TABLE 1

| No. | Treatments | Doses | Application |
|---|---|---|---|
| 1 | Control | — | Daily, just pellet |
| | | | (Poultry feed) |
| 2 | Present | 0.1% humic acids + | Daily on pellet |
| | composition | ureides | (Poultry feed) |

Sample Preparation:

Poultry was fed with two different balanced pellets poultry feed. The first two weeks the poultry was fed with “starter pellet” and the rest of the weeks it was fed with “Finisher”. The “Starter” pellets were mixed with 0.1% of humic acids+ureides. The “Finisher” pellets were mixed with 0.1% of humic acids+ureides

The sample size (n) of each treatment was 50 chickens.

Application: Directly mixed on poultry feed.

Number of applications: Daily, based on chicken consumption. Instruments: Feeder

Experimental design & evaluation:

TABLE 2

| No. | PARAMETER | EVALUATION |
|---|---|---|
| 1 | Food consumption in | Food weighing |
| | grams/day | |
| 2 | Weight per week | Weighing each chicken |
| 3 | Mortality | Percentage |
| 4 | Food conversion | Kg feed/weight chickens |

The chicken weight was measured at the end of each week. An average was taken for analysis. The feed addition was measured daily.

Results:

Treatment of the chicken poultry with Humic acids+ureids has shown substantial improvement in the mortality reduction compared with the control. This parameter is very valuable for the farmer since the economic losses are reduced substantially. Treatment with Humic acids reduced mortality in 105 compared with the untreated control.

Another valuable parameter for the farmers is the food consumption, especially since the food represents the higher cost of the operation. As the results show, humic substances+ureids helps reducing the food consumption in 6% compared to the control, this is very important considering that the treatment had less mortality than the control hence using less food to feed more chicken.

In poultry, feed conversion ratio (FCR) or feed conversion rate is a ratio or rate measuring of the efficiency with which the bodies of livestock convert animal feed into meat. The result shown in Table 3 shows that the Food conversion ratio is improved with treated with Humic Acids+ureids.

| | | Weight | | | Food | |
|---|---|---|---|---|---|---|
| | | at 6.5 | | Food | Consumed/ | Food |
| | | weeks | Mortality | Consumed | Chicken | Conversion |
| No. | Treatment | (Kg) | (%) | (Kg) | (Kg) | Ratio |
| 1 | Control | 2.55 | 23% | 269.5 | 6.087 | 2.32 |
| 2 | 0.1% | 2.67 | 12% | 253.73 | 5.579 | 2.23 |
| | Humic + | | | | | |
| | Ureids | | | | | |

It is thus observed that the Food conversion ratio is significantly improved when treated with Humic Acids+ureids as compared to control.

1. An animal feed additive composition comprising an effective amount of a humic substance and an ureide compound.

2. The composition as claimed in claim 1, wherein said humic substance is leonardite.

3. The composition as claimed in claim 1, wherein said ureide compound is at least one compound selected from the group consisting of 2, 2-diureidoacetic acid, citmlin (2-amino-5-ureidopentanoic acid), S-ureido glycine, glyoxyldiureide, S-ureidoglycolate, and salts thereof.

4. The composition as claimed in claim 3, wherein the said ureide is glyoxyldiureide or its salts.

5. The composition as claimed in claim 1, wherein the composition further comprises at least one plant extract.

6. The composition as claimed in claim 5, wherein the plant extract is a digestive, antimicrobial, biostimulant or aromatic plants from the families: Lamiaceae, Zingiberaceae, Apiaceae, Myrtaceae, Musaceae, Oleaceae, Arecaceae, Alliaceae, Meliaceae, Asteraceae, Poaceae, Piperaceae, Cupresaceae, Rutaceae; lemon balm fluid extract, ginger extract powder, fennel fluid extract and/or a combinations thereof.

7. The composition as claimed in claim 1, wherein the composition further comprises at least one component selected from the group consisting of vitamins, minerals, trace minerals, amino acids, health supplements, pharmaceuticals, plant extracts, phytonutrients, carotenoids, enzymes, probiotics, lignosulfonates, organic acids, and combinations thereof.

8. The composition as claimed in claim 1, wherein the composition is fed to an animal as dietary supplement.

9. The composition as claimed in claim 8, wherein the composition is fed to livestock.

10. The composition as claimed in claim 8, wherein the said composition is a dietary supplement for a broiler chicken.

11. A process of preparing the additive composition of claim 1 comprising a. mixing the humic acid substance with the ureides, and b. optionally, treating said humic acid substance with an alkali solution prior to mixing for activation.

12. The process of claim 11, wherein the said alkali solution is sodium hydroxide, potassium hydroxide, or a mixture thereof.

13. A method for improving feed digestion in animal production, comprising feeding the animal with a feed containing the additive composition of claim 1.

14. A method of promoting the health and enhancing performance-enhancing in animals, by administering to an animal the composition of claim 1.

15. (canceled)
